(19) United States
(12) Patent Application Publication
(10) Pub. No.: US 2006/0044741 A1
(43) Pub. Date: Mar. 2, 2006

(54) Method and system for providing a dynamic window on a display

(75) Inventor: Christopher F. Bussan, Crystal Lake, IL (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 10/930,372

(22) Filed: Aug. 31, 2004

(51) Int. Cl. G06F 1/16

(52) U.S. Cl. 361/681; 345/169

(57) ABSTRACT

A communication device (101) includes a display (103) screen for displaying images to a user; an image input (105) for detecting and capturing a series of images, including a prior image and subsequent images; and a processor (107). The processor (107) is configured to facilitate receiving, from the image input (105), the series of images; to facilitate displaying images received from a receiver (111) on the display (103) screen; and to facilitate determining whether the subsequent images have changed in a pre-determined manner from the prior images. A window can be provided on the display, for example to display the series of images from the image input (105). The presence or absence of the window is controlled by a determination that the subsequent images have changed in the pre-determined manner from prior images. When the images are changed, the window is deployed on the display, and when the images are stable, the window is removed from the display.

### FIELD OF THE INVENTION

The present invention relates in general to wireless communication units and wireless networks, and more specifically to communication units suitable for displaying video.

### BACKGROUND OF THE INVENTION

Many of today's communication devices include connectivity to various imaging devices such as still-imaging and video cameras. Such imaging devices allow the device user to take pictures, view them on a display of the communication device, and send them to another device which supports the same imaging and communication standard. Some communication devices further provide capability to send photographs taken by other electronic devices such as personal computers and the like. Further, some communication devices include built-in cameras. These imaging devices provide device users the capability to participate in imaging communication. A user of such a communication device can input and send images to another device for use by another communication participant. In addition, the user may receive images from another communication participant device. The user may view the received images on the display of the communication unit. This enables not only the traditional voice communication, but also visual communication.

While the user is holding the communication device, it may be difficult, at times, to retain the stability of the imaging input. Consequently, a user may wish to be able to ensure not only that the initial images are as expected, but also that the image input (such as a camera) attached or within their communication device remains aimed correctly, in order to provide the desired images to the various recipient devices. If the user can detect that the video camera is no longer aimed properly, the user can reposition the image input accordingly.

To enable the user to simultaneously see what is being transmitted to the recipient, together with what the user is receiving, some communication devices divide the display to provide a picture-in-picture window. Accordingly, the display displays the received images, and the picture-in-picture displays the images being transmitted.

Unfortunately, the picture-in-picture window consumes valuable display space. Moreover, the picture-in-picture window can obscure the image being received, and may be undesirable or distracting.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a diagram illustrating a simplified and representative communication environment associated with visual communication units;

FIG. 2 is a diagram illustrating an exemplary display of a communication unit when participating in a visual communication;

FIG. 3 is a block diagram of an exemplary communication unit;

FIG. 4 is a flow chart illustrating an exemplary procedure for providing a dynamic window on a display;

FIG. 5 is a flow chart illustrating an exemplary procedure for determining whether an image has sufficiently changed; and

FIG. 6 is a flow chart illustrating exemplary parallel procedures for processing images for a window on a display and received images.

### DETAILED DESCRIPTION

In overview, the present invention relates to wireless communications devices or units, often referred to as communication units, such as cellular phone or two-way radios and the like having visual image communication capability. Such capability may be encountered in a video or still-image communication associated with a communication system such as an Enterprise Network, a cellular Radio Access Network, or the like. Such communication systems often also provide services such as voice or data communications services. More particularly, various inventive concepts and principles are embodied in systems, communication units, and methods therein for processing visual images associated with a call (or other communication) from a communication unit with visual imaging capability, for example, to another communication unit or combination of units having compatible visual imaging capability.

It should be noted that the term communication unit may be used interchangeably herein with subscriber unit, wireless subscriber unit, wireless subscriber device or the like. Each of these terms denotes a device ordinarily associated with a user, for example, a wireless mobile device that may be used with a public network, for example in accordance with a service agreement, or within a private network such as an enterprise network. Examples of such units may include, by way of example, video telephones, personal digital assistants, personal computers equipped for communication over a network, a cellular handset or device, video conference equipment, or equivalents thereof provided such units are arranged and constructed for operation in connection with visual image communications.

The communication systems and communication units of particular interest are those providing or facilitating visual image communications services or transfer and/or display of visual image data or messages over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Visual image transmission and/or reception generally may be provided over the network or to and/or from communication units with visual image capability in accordance with procedures and devices known to those of skill in the art.

Furthermore, the wireless communication units or devices of interest may have short range wireless communications capability normally referred to as WLAN (wireless local area network) capabilities, such as IEEE 802.11, Bluetooth, or Hiper-Lan and the like using, for example, CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively, the wireless communication units or devices of interest may be connected to a LAN (local area network) using protocols such as TCP/IP, UDP/UP, IPX/SPX, or Net BIOS via a hardwired interface such as a cable and/or a connector.

The present disclosure is provided to further explain in an enabling fashion exemplary modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. Indefinite articles such as a, an, or no article are intended to mean one or more, at least one, and the like.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof can be advantageously employed to enable the user to view not only images that the communication device is receiving, but also images that the imaging input unit on the communication device is receiving at appropriate points, for example when the image being input may have shifted or changed. The user can view what is being transmitted from the communication unit to the recipient or other participant in a visual image communication, together with what the user is receiving, at appropriate points, while reducing problems encountered where the window on the display, such as a picture-in-picture window, may be obscuring the received images being displayed or may be otherwise consuming display space.

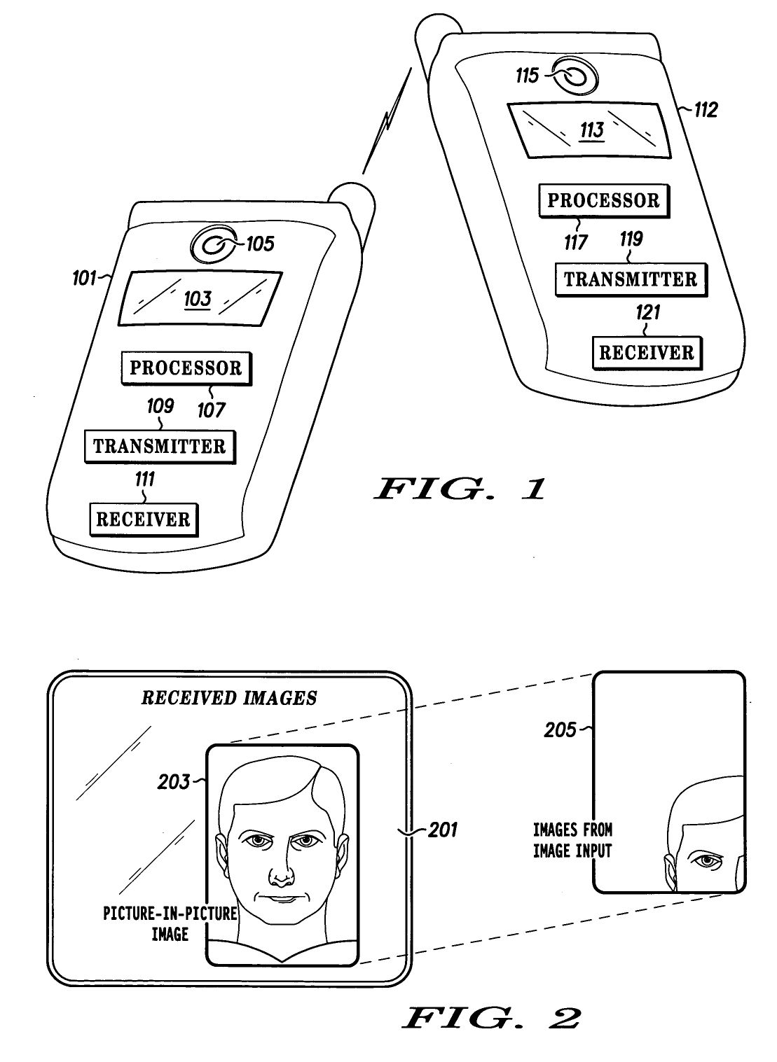

Referring now to FIG. 1, exemplary embodiments of a dynamic window for a display on a communication unit will be discussed and described. FIG. 1 is a block diagram illustrating a simplified and representative environment associated with communication units 101, 112 in communication with each other, performing transmission and/or reception of image data, for example in a video call or other type of communication including the communication of image date, in accordance with various exemplary embodiments. Accordingly, the communication unit 101, 112 include, respectively, a display 103, 113 for displaying image information, and an image input 105, 115, represented in the exemplary illustration as an input or lens for a built—in camera. In the illustrated example, two communication units 101, 112 are communicatively connected, such as participating in a visual and/or audio plus visual call. Each communication unit 101, 112, respectively includes a processor 107, 117 for processing information, a transmitter 109, 119 for transmitting communications, and a receiver 111, 121 for receiving communications. Further discussions will use communication unit 101 and constituent elements 103-111, where it is understood that the functionality and structure for communication unit 112 and respective elements are similar.

An image that is received by the image input 105 can be transmitted to the other communication unit 101, and/or the receiving communication unit 101 can display the received image or series of images on the display 103. Moreover, the display 103 can provide a window in addition to the principal images being displayed on the display, for example, a picture-in-picture window or a divided display space for other images.

In addition to presenting the received image or series of images on the display, the display may provide other information, for example text communications to the user. The display may be constructed in accordance with, for example, known techniques, so as to present images provided as input from the image input. The display may be, by way of example, a conventional liquid crystal display (LCD) or other visual display.

The image input 105 may include, for example, a camera or other image sensor capable of detecting an image and transmitting the detected images as data, for further processing within the communication unit, for example, the data can be sent to the processor 107. The image input, e.g. camera, can be, as depicted, integral with the communication device. In this situation, the communication device and thus image input can be particularly susceptible to motion. Consequently, the image input can experience instability and the images received by the image input can change relative to movement of the communication device itself. Alternatively, the image input device may be separable or separate from a main portion of the communication device such that it can be positioned separately from the communication device itself while still remaining in communication therewith. It is anticipated that a user may not be providing constant surveillance of the position of the video input during the user's operation of the communication device during typical use. Hence, during standard operation and without cues or other alerts thereto, a user may not be aware of a change in position of the image input.

One or more buffers (not illustrated) may be provided in connection with the display and/or the image input device, in order to be able to buffer images or data representing the images. The optional buffer can be utilized in connection with received images, images to be transmitted, and or images that are temporarily stored for internal purposes.

Used in accordance with one or more embodiments, the display 103 can display the images received at the communication unit 101. The window on the display can display, inter alia, the images being transmitted. One or more exemplary and alternative embodiments provide that the display 103 is divided into two or more divisions. The images being transmitted and the images being received from the communication network can be displayed in their respective divisions of the display. In addition, the window may be displayed in alternative and/or changing locations on the display 103.

One or more exemplary embodiments provides for an initial display of the images detected by the image input in the window. The initial display and/or a re-display can be provided until the image from the image input 105 becomes sufficiently stable to be deemed acceptable, e.g. stable. The sufficiency of stability of the image input can be determined, for example, in accordance with exemplary processes and/or devices described below.

When the image or series of images received by the image input 105 fails to change sufficiently ( described below), for example such as may happen when the image input is stationary, the window can be automatically removed, minimized, or otherwise displaced from the portion of the display. On the other hand, when the image or series of images being received by the image input 105 changes sufficiently, for example when the user redirects the image input 105, the window is re-displayed. Once the window is re-displayed, the communication device can wait for a determination that the image input is sufficiently stable to be deemed acceptable, in order to remove the window. The display, or at least the portion from which the window was removed, can be refreshed if necessary or desired to display the principal image, for example image being received, on the display.

According to various alternative and exemplary embodiments, the window is removed or re-displayed in accordance with processes including fade out and/or fade in, dissolve, shrink or enlarge, or other ways of causing images to appear or disappear. The method of appearance/disappearance of the window can be user-selectable.

When a user is holding the communication unit, the communication unit in operation may be operated by the user to focus typically, for example, on the user's face, such that the image of the user's face is transmitted to the recipient when the user is talking. Similarly, the recipient may focus on the recipient's face, in order that the two may simulate a face-to-face communication. Whilst utilizing the communication unit in this fashion, the communication unit may experience situations including, for example, that the user's thumb and/or fingers covers the image input, that the focus of the image input gradually travels upward or downward, and/or that the user is in motion such as walking and thereby causing the communication unit to be shaken.

A determination that the image has changed sufficiently can be made based on, for example, a change in a subsequent image (or series of received images) from one or more prior images, or a motion detector or sensor provided in connection with the communication unit. As used herein, the terms “subsequent image”, “subsequent images”, “prior image” and/or “prior images” are utilized to differentiate between the order of receipt of one or more images in a sequence of images. According to exemplary and alternative embodiments, a “subsequent” image or images and a “prior” image or images can be received, input, or viewed with intervening images.

Alternative and exemplary embodiments provide that the determination of a sufficient change is made over a series of subsequent images and/or a series of prior images, and optionally can omit intervening images. A determination that the image has changed sufficiently can accommodate different types of changes, for example, a gradual change, a sudden change and/or rapidly iterative changes. Furthermore, according to one or more exemplary and alternative embodiments, the communication unit can be provided with an override feature such that one or more types of change, or any change, is not recognized. A determination of change may be made based on observations of one or more of the prior images and one or more of the subsequent images made, for example, over a period of time, over a number of changed images, or based on a maximum number of changes or a maximum amount of change.

A determination of change may be made, for example, by comparison of one or more subsequent and one or more prior images in accordance with known technology, for example, by one or more of the following, alone or in combination: detection of one or more features, detection of one or more edges, detection of motion in the images, detection of motion from a motion sensor, matching of one or more patterns found in the prior and subsequent images, analysis of image differencing, analysis of background/foreground separation, detection and comparison of one or more objects centered in the images, and/or detection and comparison of one or more objects in the foreground of the images. For example, where the determination includes at least a detection and comparison of centered objects, if the determination detects that the centered object as determined over several prior images has moved away from center over a long period of time, the determination may be that the image has sufficiently changed; if the determination detects that the centered object as determined over several prior images is missing in a subsequent image, the determination may be that the image has sufficiently changed.

The determination that an image or series of images has changed can be accomplished according to known techniques. For example, the most recent series of prior images and/or subsequent images can be stored in a buffer, for utilization in comparison of the image data. The processor in the communication unit can be programmed or otherwise configured to utilize one or more methods of determining whether the images have changed.

The term window as used herein is intended to refer to an area on the display screen that displays its own image data or messages independently of the other areas of the display. Typically, the received images are provided in the display, and the images from the image input are provided in the window. The window may include, for example, a picture-in-picture window, a situation wherein the display is divided into two or more separate windows for the received images and the input images, and/or where the display includes separate windows for the received images and the input images that overlap partially or entirely.

The processor 107 can be coupled to the display 103 in a manner so as to be able to control at least the images provided on the display in accordance with known techniques and devices. In addition, the processor 107 can be coupled to the image input 105 in a manner so as to be able to receive images that are detected by the image input 105 and to optionally transmit the detected images via a transmitter, for example as in known techniques. Known techniques and devices provide, for example, for receiving images, such as image data in a communication, where the received images are displayed on the display 103. Further, known techniques provide for a processor controlling the presence, absence, and/or aspects of a visual appearance of a window in a video display 103 of a communication unit in response to a manual command, such as a button activation or menu selection. Known techniques also provide for a processor to transmit a specific image over a transmitter.

FIG. 2 is a diagram illustrating an exemplary display 201 of a communication unit, arranged in accordance with various exemplary embodiments. In overview, in the illustrated exemplary embodiment, the display 201 provides a display of, for example, received images or other information provided to the user, and of an optional picture-in-picture image 203. The window consumes display space, and can obscure images or information appearing in the display 201. As further described herein, the window and the image therein 203 may be removed from the display 201 in response to a determination that the image is sufficiently stable, and/or the window may be caused to reappear on the display in response to a change in image(s) which is determined to be sufficient. Further, the picture-in-picture image, when displayed, may reflect images detected by the image input.

Images from the image input 205, for example received from a video or still camera on the communication unit, may be provided for use as the picture-in-picture image 203, whereby the user can view what is being or will be transmitted to the recipient. Alternatively, according to exemplary embodiments, one or more alternative images may be provided for use in transmission to the recipient, for example, when it is determined that the image received by the image input has changed sufficiently so as to exceed pre-determined standards (as explained further herein). It then may be desirable to continue transmitting one or more of the prior images or other selected images or text instead of the changed subsequent images whilst the user re-adjusts the image input.

According to the illustrated exemplary embodiment, images received by the communication unit as video communications having video data and/or still image communications having still image data can be displayed on the display 201. The images received as communications are typically displayed in sequential fashion on the display 201, in accordance with known techniques. The images displayed on the display 201 may be controlled via the processor, previously discussed. Typically, images, for example, including video data and still image data in accordance with known formats, such as may be received by the communication unit as communications, are displayed in the display.

According to exemplary and alternative embodiments, the communication unit can be arranged so as to display a stored image or sequence of images rather than the input images 205. For example, when the user has moved, it can be disconcerting to the recipient to view a bouncing or partial image; in such a situation, the device can retrieve and transmit the stored image, sequence of images, or other image or text, to the recipient instead of the input images 205.

The display 201 can be controlled, for example by the processor, to initially include the images from image input within the picture-in-picture image 203. When the image has stabilized, such as may be determined when the changes between subsequent images are sufficiently within a pre-determined difference, the window can be removed from the display 201. Similarly, when the image becomes destabilized, such as when subsequent images are experiencing a sufficient amount of change, for example as by the image 205, the window can be re-deployed on the display 201, so that the user can re-adjust a direction of the camera.

One or more alternative and exemplary embodiments provide that the display 201 and/or window can be utilized to instruct the user in re-positioning the image input to approximately the same prior position, in relation to the prior image. For example, the outline of a centered object (such as a head shot) can be displayed in the window, thereby allowing the user to re-position the communication unit and/or video input to the prior position. As another example, text can be provided on the display and/or the window to instruct the user in stabilizing the video input, for example, “CENTER OBJECT” when the object centering determination determines that the image has changed. According to exemplary and alternative exemplary embodiments, the display can be utilized to provide guidance of how to re-position the image input in order to better align the present images. Optionally, indications on the communication unit, for example, arrow keys on the display, on the keypad, and/or the location of an illuminated keypad LED (Light-Emitting Diode) can indicate the direction to move and/or rotate the communication unit.

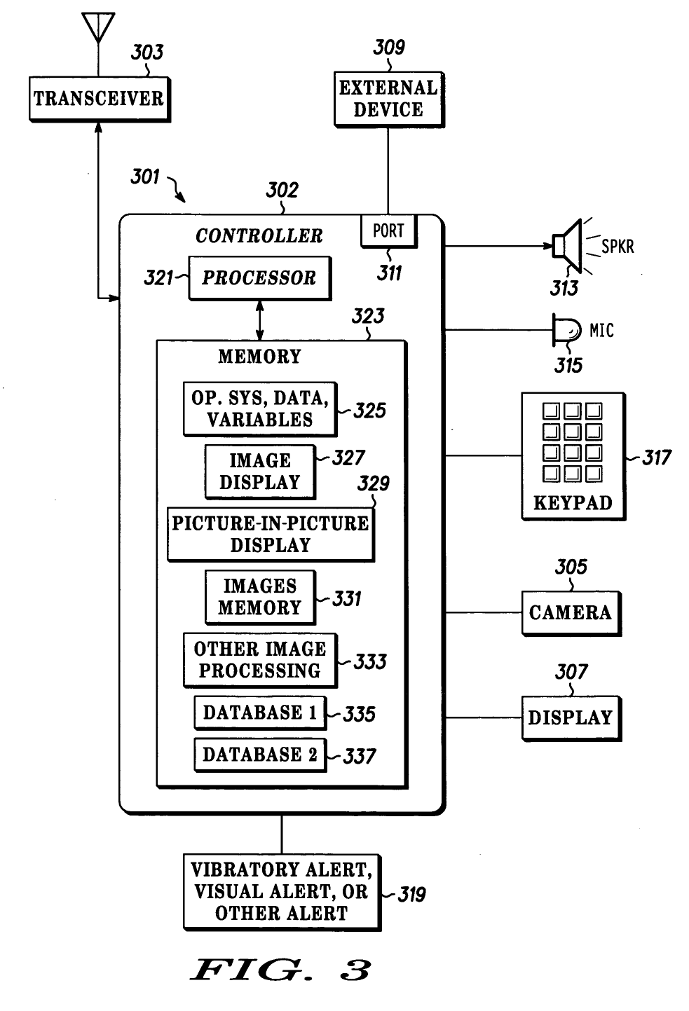

FIG. 3 is a block diagram of an exemplary communication unit 301 according to one or more embodiments. The communication unit 301 may include, inter coupled as generally depicted, a controller 302, a transceiver 303, an image input 305 such as a camera, a display 307, a speaker 313, a microphone 315, an alerting device 319 for providing vibratory alert, visual alert, or other alert, and/or a user input device such as a keypad 317. A headset (not shown) may incorporate the speaker 313 and microphone 315. The controller 302 further comprises, inter coupled as noted, a communication port 311 for communication with an external device 309, a processor 321, a memory 323, and various other features that are not further relevant here but which will be understood by those of ordinary skill in the art.

The processor 321 may comprise one or more microprocessors and/or one or more digital signal processors. The memory 323 may be coupled to the processor 321 and can comprise one or more of a read-only memory (ROM), a random-access memory (RAM), a programmable ROM (PROM), and/or an electrically erasable read-only memory (EEPROM). The memory 321 may include multiple memory locations for storing, inter alia, an operating system, data and variables 325 for managing general execution by the processor 321; computer programs for causing the processor to operate in connection with various functions such as an image display function 327, a picture-in-picture display function 329, a call transmit/receive function (not illustrated), and/or other image processing 333; images memory 331 for buffer and/or storing images which are received or which can be transmitted; a database 335 of various other image data; and/or a database 337 for other information used by the processor 321. The computer programs can direct the processor 321 in controlling the operation of the communication unit 301.

According to one or more embodiments, the processor 321 may be programmed to alert the user to a change in the image by way of the alerting device 319. The alerting device 319 may use a conventional vibration or audible alerting mechanism, visual alert, and/or other alert, or a combination thereof.

The user may invoke functions accessible through the user input device 317. The user input device 317 may comprise one or more of various known input devices, such as a keypad, a computer mouse, a touchpad, a touch screen, a trackball, and/or a keyboard.

Responsive to receipt of images from the transceiver 303, in accordance with instructions stored in memory 323, the processor 321 may direct the received images to the display 307. Also, in response to images input to the camera 305 or other image input device, the processor 321 may direct the input images to be transmitted over the transceiver 303. The display 307 may present received images and/or input images, to the user by way of a conventional liquid crystal display (LCD) or other visual display, optionally including the window. One or more exemplary embodiments provide for buffering of images, for example in the images memory 331, including for example received images, input images from the image input 305, and/or images temporarily stored for later use.

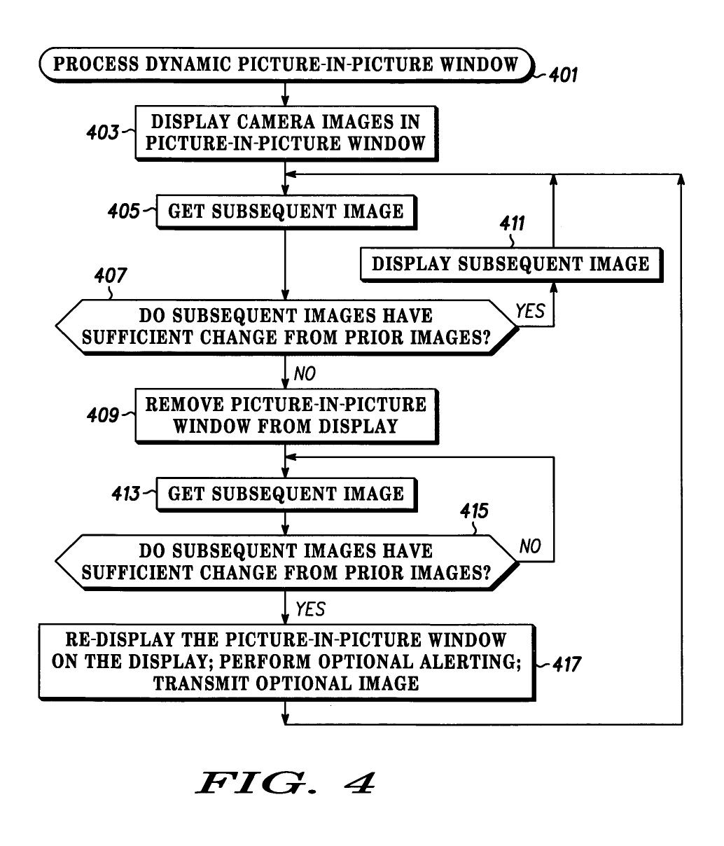

FIG. 4-6 will now be discussed and described, in connection with one or more exemplary method embodiments. FIGS. 4-6 provide flow charts of exemplary procedures for providing the dynamic window, for determining whether an image being received by the image input meets pre-determined standards so as to be deemed sufficiently changed and/or stable, and for illustrating an exemplary dual-processing flow for processing images on the display device and in the window. Advantageously, the processes described herein can be implemented, at least partially, in a processor, such as the processor/controller of communications device 301.

FIG. 4 is a flow chart illustrating an exemplary procedure for providing a dynamic window 401. According to the illustrated embodiment, images from the image input are initially displayed, for example, in the picture in picture window 403. The processor preliminarily loops until the image becomes stabilized and no longer experiences changes, before removing the picture-in-picture image from the display. Accordingly, in the illustrated example embodiment, at 405, the processor gets the subsequent image, such as from the image input, and checks whether the subsequent image or subsequent images have experienced sufficient change (further described herein) from one or more prior images, at 407. When it is determined that there is sufficient change, then the subsequent image is displayed 411 and the processor loops to get the next, subsequent image. The processor thereby continues to provide a display of the window with the current image detected by the image input whilst the positioning of the image input, and consequently the detected image, is stabilizing.

When it is determined that the subsequent images do not have sufficient changes from prior images in 407, then the window is removed from the display 409.

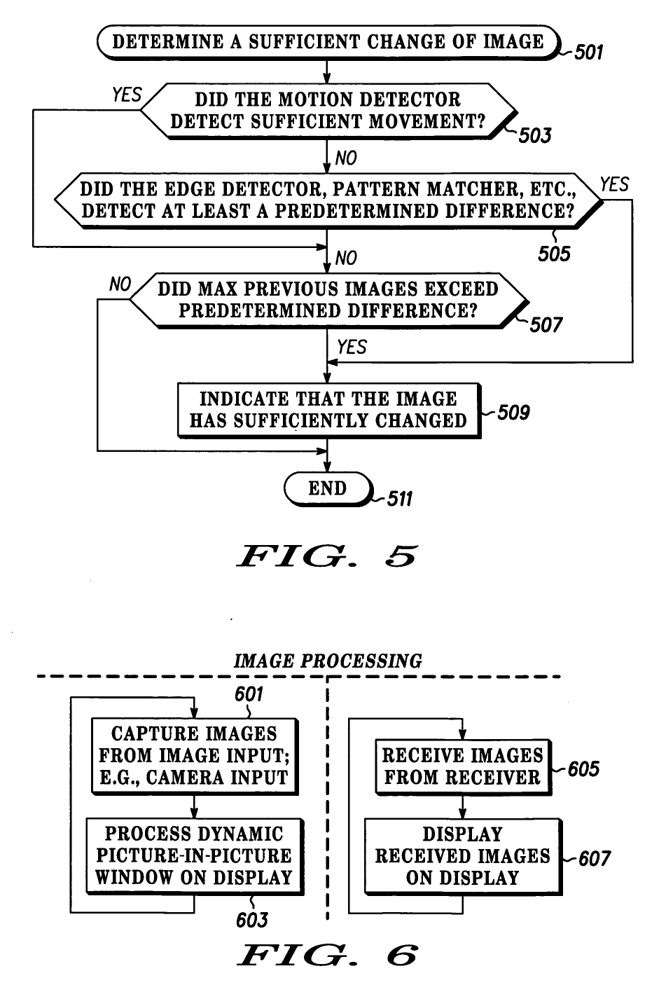

The processor then awaits a determination that the image input is detecting one or more images which are determined to meet pre-set standards establishing that the images are sufficiently different, at 413, 415 and 417. Hence, at 413, the processor gets the subsequent image, such as from the image input, and checks whether the subsequent image or subsequent images have experienced sufficient change from one or more prior images, at 415. According to one or more exemplary and alternative embodiments, a determination of whether there is sufficient change can be implemented as illustrated by way of example in connection with FIG. 5 discussed below.

When it is determined that sufficient change is not present at 415, then there is no need to display the image from the image input, such as in the window, and the processor loops to get the next, subsequent image at 413. The processor thereby continues to check whether the images detected by the image input have changed, so that the window should be re-deployed, with the current, changed image detected by the image input, in order to assist with the user's positioning of the image input. When it is determined that the subsequent images have experienced sufficient changes from prior images at 415, then the window is redeployed on the display 417.

The process then loops to 405 to perform processing associated with permitting the user to stabilize the image detected by the video input, as discussed above. According to one or more embodiments, the process can be repeated as necessary or desired. Optionally, the process may terminate pursuant to a user request.

FIG. 5 is a flow chart illustrating an exemplary procedure for determining whether an image has sufficiently changed 501. This procedure may be advantageously implemented with a processor as earlier noted and herein discussed or other appropriately provisioned apparatus. At 503, the process performs an optional check of whether the optional motion detection sensor has detected movement, sufficient to exceed pre-determined standards such as velocity and/or acceleration over a period of time. If not, then at 505 the processor checks whether the edge detector, pattern matcher, etc., has detected a change and whether the change exceeds a predetermined difference.

Whether or not there is a change in the subsequent image or images from the prior image or images may be made, for example, by comparison of one or more subsequent and one or more prior images in accordance with known technology, subroutines, plug-in rules, or similar for detecting image changes or differences. For example, detecting image changes or differences can include one or more of the following, alone or in combination: detection and comparison of one or more features in the images, detection and comparison of one or more edges in the images, detection of motion in the images, detection of motion in the image, matching of one or more patterns found in the prior and subsequent images, analysis of image differencing in the images, analysis of background/foreground separation in the images, detection and comparison of one or more objects centered in the images, and/or detection and comparison of one or more objects in the foreground of the images.

Pre-determined standards can be provided such that minimal variations in, for example, location of a feature, location of an edge, motion, pattern position, image differences, separation of background/foreground, and position of foreground objects, do not cause the window to be re-deployed. For example, standards with maximum and/or minimum values can be provided as appropriate based on for example experimentation. The maximum and/or minimum values can include a temporal component, so that temporary variations do not cause a re-deployment. For example, differences amongst a pre-determined number of subsequent images from the prior image(s) can be discounted when the most recent subsequent image (or multiple images) is sufficiently unchanged from the prior image(s). These and other known techniques can be used to de-bounce or filter variations in differences.

According to various exemplary and alternative embodiments, if the change does not exceed at least a predetermined difference at 505 or if the motion detector detected sufficient movement at 503, then at 507 the processor checks whether the maximum number of previous images exceeded the predetermined change or difference.

At 509, when the change exceeded at least a predetermined difference at 505 or when the maximum number of previous images exceeded the predetermined difference at 507, the processor provides an indication that the image has sufficiently changed. After the indication at 509 or when previous images did not sufficiently change at 507, the process ends at 511.

FIG. 6 is a flow chart illustrating exemplary parallel procedures for processing images for a window and received images. In the exemplary illustration, image processing executing, for example, in the processor provides simultaneous displays of images received, for example, video or still image data received in connection with a communication, together with displays of images detected by the image input. In this simplified flow chart, processing of the input images includes 601 and 603; and processing of received images includes 605 and 607.

Accordingly, at 601 the processor captures images detected by the image input, for example, a camera input. This may be performed, for example, in accordance with known techniques. At 603, the processor processes the dynamic window, e.g., a picture-in-picture window, which may be provided on the display, as has been described. The process 601, 603 can repeat until, for example, terminated by a user.

Received images are processed in parallel or in a substantially simultaneous fashion, for example, in the processor or in another processor. At 605, the processor (or other processor) receives images in accordance with known techniques, for example images which have been transmitted to it, e.g., video data received in a video call. At 607, the processor (or other processor) provides the received images on the display in accordance with known techniques. The process 605, 607 can repeat until, for example, the call is terminated or displaying the images is otherwise terminated by the user.

As can be appreciated from the discussion above, various inventive principles and combinations thereof can be advantageously employed to enable the user to view images that the image input on the communication device detects, as appropriate, to enable the user to re-position the image input unit, for example when the scene being input into the image input may have shifted or changed. Such images can be generally hidden and then presented, for example, in a picture-in-picture window that is deployed or re-deployed when it is determined that differences between prior and subsequent images have met pre-determined standards, e.g. a substantial change is detected. The window is removed from the display when the prior and subsequent images from the image input appear to be stable, for example within certain pre-determined parameters. Accordingly, the user can view what is being received, for example, from an other participant in a partial or full visual communication, together with images to enable the user to establish a desired position of the image input unit, and hence what the user is transmitting to the other participant. This can reduce problems encountered where the window may be obscuring part of the display. These concepts and principles can be especially useful and advantageously utilized when the images are video images or other quasi continuous, e.g. regularly/periodically updated, images.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication device comprising:
a display for displaying images to a user;
an image input for capturing a first plurality of images, including a prior image and subsequent images; and
a processor, coupled to the display and the image input, wherein the processor is configured to facilitate receiving, from the image input, the first plurality of images; to facilitate displaying a second plurality of images on the display and displaying the first plurality of images in a window on the display; and to facilitate determining whether at least one of the subsequent images has changed in at least one pre-determined manner from the prior image, and responsive to the determination, controlling a presence of the window on the display.

2. The communication device of claim 1, further comprising:
a transmitter for transmitting the first plurality of images, when operably connected to a communication network.

3. The communication device of claim 1, further comprising:
a receiver coupled to the processor, for receiving the second plurality of images, when operably connected to a communication network.

4. The communication device of claim 1, wherein the determination is based on a periodic comparison of at least one of the subsequent images to the prior image to determine if objects in the subsequent image have changed or moved.

5. The communication device of claim 1, wherein the window is removed from the display when at least one of: (i) a pre-determined time period expires during which the subsequent images do not change in the at least one pre-determined manner from the prior image; and (ii) at least one of the subsequent images is determined to not have changed in the at least one pre-determined manner.

6. The communication device of claim 5, wherein it is determined that the at least one of the subsequent images has not changed, based on at least one pre-determined difference between the prior image and the at least one of the subsequent images including at least one of: feature detection, edge detection, motion detection, pattern matching, image differencing, background/foreground separation, centered object detection, and foreground object detection.

7. The communication device of claim 1, wherein the window is re-displayed on the display when at least one of: (i) a pre-determined time period expires during which the subsequent images are determined to be changed in the at least one pre-determined manner from the prior image; and (ii) at least one of the subsequent images is determined to be changed in the at least one pre-determined manner from the prior image.

8. The communication device of claim 7, wherein it is determined that the at least one of the subsequent images has changed, based on a pre-determined difference between the prior image and the at least one of the subsequent images including at least one of: feature detection, edge detection, motion detection, pattern matching, image differencing, background/foreground separation, centered object detection, and foreground object detection.

9. The communication device of claim 1, wherein the prior image is saved in a memory, and selected ones of the subsequent images are periodically compared to the prior image to determine whether the subsequent images received from the image input have re-positioned from the prior image.

10. The communication device of claim 1, wherein the processor is further configured to facilitate producing an alert, responsive to the determination that the at least one of the subsequent images has changed, the alert including at least one of an audible alert, a tactile alert, a haptic alert, and a visual alert.

11. The communication device of claim 1, wherein the processor is further configured to facilitate providing instructions to a user, responsive to the determination that the at least one of the subsequent images has changed, to facilitate matching a current image from the image input with the prior image.

12. The communication device of claim 1, wherein the processor is further configured to facilitate selecting the prior image, responsive to a user instruction.

13. The communication device of claim 1, wherein the processor is further configured to facilitate, responsive to a user instruction, at least one of: (i) displaying the window, and (ii) transmitting the prior image instead of the first plurality of images over a transmitter.

14. A method for providing a dynamic window on a communication device, comprising:
capturing, at a processor via an image input, a first plurality of images including a prior image and subsequent images;
receiving, at the processor, from a receiver, a second plurality of images, and displaying the second plurality of images on a display;
displaying the second plurality of images on the display, in a window; and
determining whether at least one of the subsequent images has changed in at least one pre-determined manner from the prior image, and responsive to the determination, controlling a presence of the window on the display.

15. The method of claim 14, further comprising re-displaying the window on the display if at least one of the subsequent images is determined to be changed.

16. The method of claim 15, wherein it is determined that at least one of the subsequent images has changed, based on a pre-determined difference between the prior image and the at least one of the subsequent images including at least one of: feature detection, edge detection, motion detection, pattern matching, image differencing, background/foreground separation, centered object detection, and foreground object detection.

17. The method of claim 14, further comprising producing an alert, responsive to the determination that the at least one of the subsequent images has changed, the alert including at least one of an audible alert, a tactile alert, a haptic alert, and a visual alert.

18. The method of claim 14, further comprising providing instructions to a user, responsive to the determination that at least one of the subsequent images has changed, to facilitate matching a current image from the image input with the prior image.

19. A computer-readable medium comprising instructions being executed by a processor in a communication device, the instructions including a computer-implemented method for providing a dynamic picture-in-picture window on a display of the communication device, the instructions for implementing the steps of:
capturing, via an image input, a first plurality of images including a prior image and subsequent images;
receiving a second plurality of images from a receiver, and displaying the second plurality of images on the display;
displaying the second plurality of images on the display, in a picture-in-picture window; and
determining whether at least one of the subsequent images has changed in at least one pre-determined manner from the prior image, and responsive to the determination, controlling a presence of the picture-in-picture window on the display.

20. The medium of claim 19, further comprising instructions for at least one of: (i) re-displaying the picture-in-picture window on the display if at least one of the subsequent images is determined to be changed, and (ii) removing the picture-in-picture window from the display if at least one of the subsequent images is determined not to be changed.
